(19) United States
(12) Patent Application Publication
(10) Pub. No.: US 2004/0034596 A1
(43) Pub. Date: Feb. 19, 2004

(54) Electronic payment management

(76) Inventors: Jeremy Light, London (GB); Stephen Mills, St. Albans (GB); Simon Welland, London (GB)

Correspondence Address: STEPHAN J. FIJIPEK, Fish & Richardson P.C., Suite 2800, 45 Rockefeller Plaza, New York, NY, 10111, US

(21) Appl. No.: 10/223,557

(22) Filed: Aug. 19, 2002

(51) Int. Cl. G06F 17/60

(52) U.S. Cl. 705/40

(57) ABSTRACT

Techniques for managing electronic payment instructions include providing a first bank with access to electronic payment instructions associated with a customer account of the first bank and providing a second bank with access to electronic payment instructions associated with a customer account of the second bank. An electronic payment instruction is received over a network from the customer of the first bank, the instruction is to pay, or receive payment from, the customer of the second bank. The electronic payment instruction is stored and sent to at least one of the first bank and the second bank to initiate payment between the customer account of the first bank and the customer account of the second bank.

### BACKGROUND

This invention relates to electronic payment management.

Payment initiation over the Internet is an important factor in the continued growth of electronic transactions—without it, invoicing and payments may continue to be processed offline, thereby degrading the efficiency of electronic business processes.

Currently, payments can be initiated over the Internet using credit card information, or using applications customized to interface into local banks and clearing systems. For example, in the United Kingdom, a banking automated clearing system (BACS) is a clearing system used for automated direct debits and direct credits. Credit card transactions may be costly for merchants and are suitable mainly for low value payments (e.g. $5-$500). In addition, there may be concern among purchasers regarding security of information in credit card transactions over electronic channels. Moreover, current payment systems may not be able to provide merchants with a common means of making electronic payments using a range of different payment types (e.g. conditional, guaranteed) typically used in domestic and cross-border trade.

### SUMMARY

In one aspect, the invention provides techniques for managing electronic payment and money-movement instructions that include providing a first bank with access to electronic payment instructions associated with a customer account of the first bank. A second bank is provided with access to electronic payment instructions associated with a customer account of the second bank. An electronic payment instruction to pay, or receive payment from, the customer of the second bank is received over a network from the customer of the first bank. The electronic payment instruction is stored and sent to at least one of the first bank and the second bank to initiate payment between the customer account of the first bank and the customer account of the second bank.

The aforesaid techniques may include receiving from the customer of the second bank an electronic payment instruction to pay, or receive payment from, a customer of the first bank. The electronic payment instruction may be stored and sent to at least the second bank and the first bank to initiate payment between the customer account of the second bank and customer account of the first bank.

The aforesaid techniques may include providing the customer of the first bank with access to configure rules associated with the electronic payment instruction, including rules for each customer, and entity level associated within a customer, of the second bank. Access to update information with the electronic payment instruction may be provided to at least the customer of the first bank, the customer of the second bank, and a third party. A bank may be provided with access to transfer ownership of a payment obligation associated with an electronic payment instruction from the customer of one bank to that bank or to any other bank having access.

The above techniques may include providing the customer of the first bank with access to approve an electronic payment instruction before it is sent to the second bank. A customer may be provided with access to view separate and combined account balance information from accounts maintained at different banks. The customer also may be provided with access to select at least one account from at least one bank to be included in a payment instruction.

The aforesaid techniques may include providing the customer of a bank with access to one or more electronic payment instructions in a database. The customer may also be provided with access to view incoming and outgoing payment instructions associated with that customer. Also, the customer of the first bank may be provided with access to services provided by the first or second bank. The first customer and the second customer may be engaged in the exchange of at least goods and services over the network.

The above techniques may include sending to the first and second banks a net electronic payment instruction based on net of one or more electronic payment instructions between customers of the first and the second bank. Rules may be stored for each bank for producing the net electronic payment instruction.

In a second aspect, the invention provides an apparatus configured to perform the techniques disclosed in the first aspect.

In a third aspect, the invention provides an article comprising a computer-readable medium that stores executable instructions for causing a computer system to perform the techniques disclosed in the first aspect.

In various implementations, the electronic payment techniques may provide one or more of the following advantages. The techniques may provide centralized storage and routing of electronic payment instructions originating from customers of one or more banks. The techniques may also allow the centralized storage and configuration of payment terms, conditions, and rules associated with companies, departments or groups within companies, or with individuals within companies, and attached to the payment instructions. Payment conditions can be maintained on behalf of one or more banks which may reduce the burden on bank management. The techniques may allow a supplier to sell and transfer payment obligations to any bank connected to the server computer.

The techniques may enable a buyer to manage its payment approval process on the server computer and integrate it into processes for creation and management of electronic payment instructions. A company can access in one place balance and payment information on all its bank accounts from one or more banks and manage its cash movements from a single point of access. The techniques may also permit companies to access banking services from one or more banks from a single point of access. The techniques also may permit banks to net off payment instructions between their customers, thereby allowing them to clear payments between themselves without using an external clearing network should they choose not to use one

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of an electronic payment system according to an embodiment of the invention.

FIG. 2 is a block diagram of a computer system according to an embodiment of the invention.

FIG. 3 is a flow diagram of an electronic payment system according to an embodiment of the invention.

FIGS. 4A-4J are screen output of an electronic payment system.

Like reference symbols in the various drawings indicate like elements.

### DETAILED DESCRIPTION

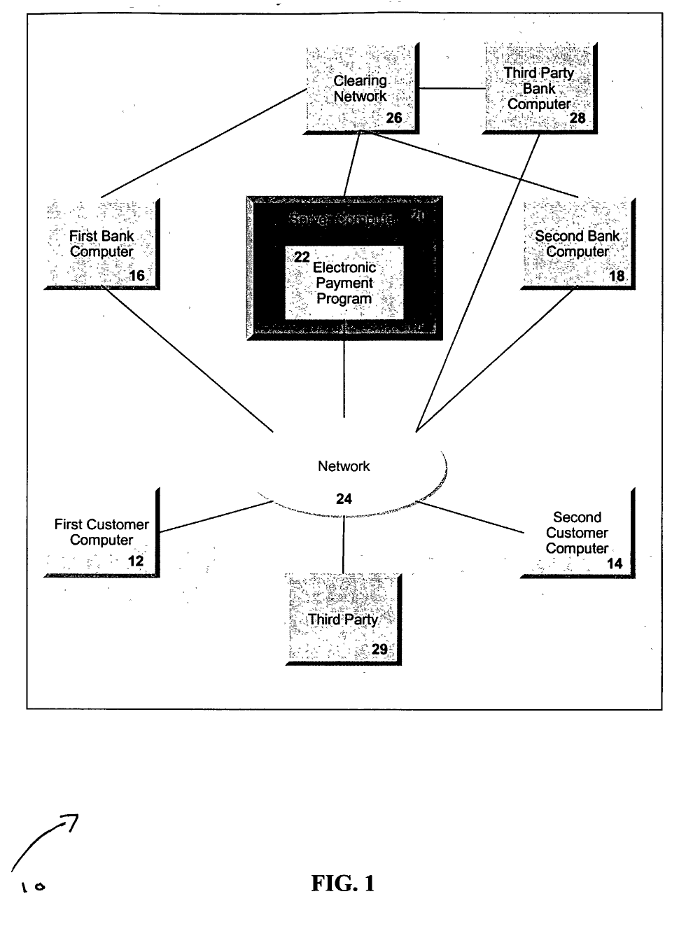

FIG. 1 is a block diagram of an electronic payment system 10 according to an embodiment of the invention. The system 10 includes a server computer 20, first and second bank computers 16, 18, and first and second customer computers 12, 14, all capable of communicating over a network 24 such as the Internet. The first and second bank computers 16, 18 are connected to a clearing network 26 which may be a network of banks (who may have bilateral agreements with each other for clearing payments between themselves), automated clearing houses and real time gross settlement systems for clearing payments between banks that are members of the network. A third party bank computer 28 is connected to the clearing network 26 as well as to the network 24. A third party non-bank computer 29 is connected to the network 24.

The first and second customer computers 12, 14 can be used by entities (corporate or consumer) to conduct business transactions such as the exchange of goods and services for value between the two computers over the network. A financial institution such as a bank can use the first bank computer 16 to provide one or more bank accounts for customers/entities (corporate or consumer) using the first customer computer 12 to satisfy payment requirements for business transactions. Likewise, the second bank computer 18 can provide one or more customer bank accounts for the second customer computer 14 to satisfy payment requirements for business transactions. Payment requirements can be satisfied by using electronic payment instructions which refers to electronic transaction data that specified payment types, rules, terms, and conditions to make payment between at least two parties to a business transaction. The server computer 20 executes an electronic payment program 22 for processing electronic payment instructions between two parties such as the first customer computer 12 and the second customer computer 14 as well as managing the instructions for the first bank computer 16 and the second bank computer 18. The two parties can also be two customers of the same bank.

To illustrate, suppose an individual using the first customer computer 12 enters into a business transaction such as the purchase of goods or services from the second customer computer 14 over the network 24. The second customer computer 14 can be a traditional retailer having an on-line presence. The retailer may be operating a Web-based server computer providing Web pages containing product and service information available for purchase over the Internet. The first customer computer 12 may use an electronic payment mechanism such as electronic payment instructions to pay for the goods or services purchased from the second customer computer 14. The electronic payment program 22 may be capable of processing electronic payment instructions based on transaction technology such as credit card technology, smart card technology, or other technology. Smart card technology may provide a more secure payment environment than traditional credit card based payment techniques. The customer computers 12, 14, the first and second bank computers 16, 18, as well as the server computer 20 may require smart card hardware and software interfaces to be able to process smart card based transactions.

The third party bank computer 28 may not be involved in the business transaction between the customer computers 12, 14 but may have an interest in the payment associated with the payment instruction. For example, the server computer 20 may permit a financial institution such as a bank to use a third party bank computer 28 to purchase a payment obligation attached to a payment to pay for goods in a business transaction between parties represented by the first and second computers 12, 14. The third party non-bank computer 29 represents an entity such as an individual or a corporation using the computer 29 to access (e.g. view, update, or other access type) payment instructions information through the network and the server computer 20. For example, a courier can use access the instruction information (e.g. a condition specifying receipt of goods) and update the information to indicate that it has received goods from the seller and has delivered the goods to the buyer.

The first customer computer 12 may be implemented using a computer (e.g. personal computer (PC), Mainframe) having a network enabled program to generate and send electronic payment instructions directly to the second customer computer 14 through a Web page provided by the second customer computer 14. Alternatively, the generation of electronic payment instructions can be integrated with existing applications residing on the first computer 12 (or the second computer 14) such as an existing accounts payable (A/P) application, supply chain management (SCM) program, or other applications. The second customer computer 14 may be able to generate electronic payment instructions similar to the first customer computer. The first and second customer computers 12, 14 may access the first and second bank computers 16, 18 through a Web based portal or through an electronic interface provided by the bank computers. The portal may allow the customer computers 12, 14 to access information provided by the banks such as financial or banking related services, company related bank account data, or other information. Although the above embodiment of the system 10 referred to first and second customer computers 12, 14 and first and second bank computers 16, 18, the system can be configured to operate with additional customer computers, third party computers, and bank computers.

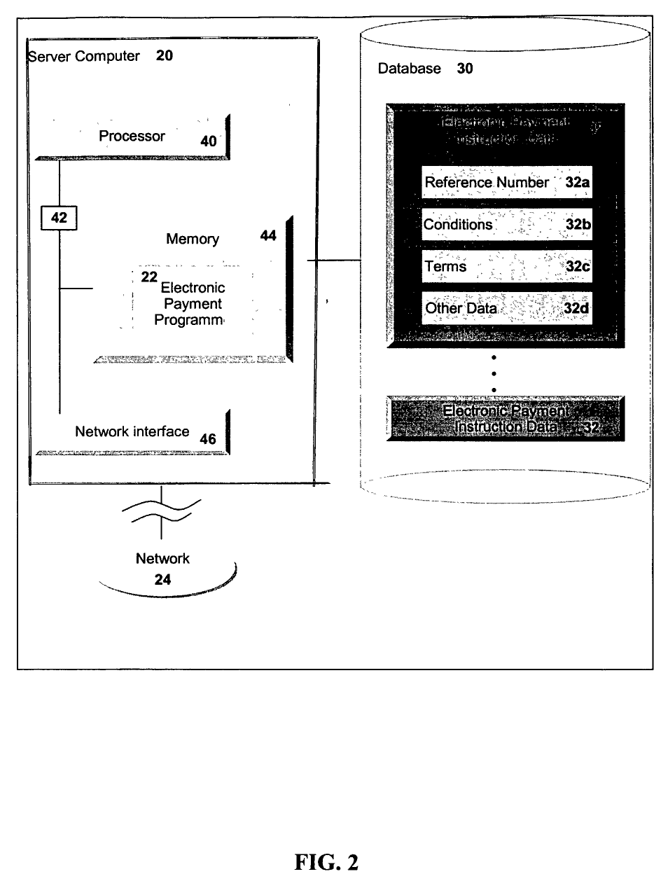

FIG. 2 is a block diagram of a computer system 20 according to an embodiment of the invention. The computer 20 can be a server computer configured as an application service provider (ASP) that can provide server based applications such as electronic payment processing applications and related services over a network 24 such as the Internet. The server computer 20 can be implemented using an operating system (OS) such as UNIX® and a computing platform provided by Sun Microsystems Inc. of Santa Clara, Calif. USA. The computer 20 may include a processor 40, a memory 44, and a network interface 46, all connected to a computer bus 42. The processor 40 executes programs and processes data stored in memory 44. The computer 20 includes the electronic payment program 22 which is a program executed in memory 44 that manages electronic payment instructions between banks and customers of the banks over the network 24. The network interface 46 can be a combination of hardware and software that may allow the server computer 20 to be accessed over the network 24 by network enabled computers such as bank computers 16,18 and customer computers 12, 14. The network interface 46 can permit the communication over the network 24 using network application protocols such as hypertext transfer protocol (HTTP) or secure HTTP (HTTPS) and the display of Web pages using hypertext markup language (HTML).

The server computer 20 is coupled to a database 30 that may allow the storage and retrieval of electronic payment instructions 32. In one embodiment, the database 30 can be implemented using a database management system (DBMS) such as an Oracle® database system from Oracle Corporation of Redwood Shores, Calif. USA. The electronic payment program 22 can handle different types of electronic payment instructions as described below. At least one electronic payment instruction 32 can be produced and stored in the database 30 for each business transaction associated between two parties such as a buyer and a seller. The electronic payment instruction data 32 includes reference number data 32a, condition(s) data 32b, term(s) data 32c, and other data 32d. The reference number data 32a can be a unique number that can uniquely identify an electronic payment instruction 32. The condition data 32b refers to conditions placed upon a payment instruction which may have been agreed upon between parties to a business transaction. For example, parties can agree that in a business transaction for the exchange of goods for value, the transaction may include payment conditions that may need to be satisfied before payment can be initiated. Such conditions may include specifying the location of the receipt of the goods, the time of receipt, documentation involved such as bill of lading, the quality of the goods upon receipt, or other conditions.

The terms data 32c refers to terms that may be attached to an electronic payment instruction. For example, the parties mentioned in the above business transaction may agree upon certain terms such as, for example, that if the buyer agrees to pay for the goods within 10 days of receipt of the goods, then the buyer may be entitled to receive a discount such as 2% from the purchase price. The other data 32d includes data related to a business transaction such as payment initiation date (e.g. that date that the payment was initiated), expected account debited date (e.g. the date that the account is expected to debited), currency data (e.g. the currency being used in the transaction), bank account credited (e.g. the bank account to be credited), amount data, payment type (e.g. conditional payment order), transaction status, or other data. The database 30 also may allow the storage of data related to entities such as companies and departments within the company. For example, the server computer 20 may allow a party to a transaction to specify profile information such as the maximum amount that a department within a company can spend on a purchase. The server computer 20 may allow parties to a transaction to access the database 30 and update the electronic payment instruction data 32 associated with the transaction.

The electronic payment program 22 can process and store in the database 30 at least the following different types of electronic payment instructions: (1) payment order, (2) conditional payment order, (3) payment obligation, (4) conditional payment obligation, (5) certified payment obligation, and (6) conditional certified payment obligation. These six payment instruction types are from the Eleanor payment scheme of Identrus LLC, Fifth Avenue, New York, and are listed here as examples of payment instruction types. The electronic payment program 22 is not limited to processing types of payments instructions from this scheme, and can process other payment types from other payment schemes that banks may choose to use. Examples of other payment types, or variations on those described, are partial payments, recurring payments and one-to-many payments (one debit, multiple credits e.g. payroll, or vice versa). Additionally, the instruction may be a money-movement instruction rather than a payment instruction (such as an instruction to move money between accounts of the same company at the same or at different banks, and in the same or in different currencies). A payment order instruction refers to an instruction that may include data specifying that a buyer (the first customer computer 12) promises to pay the seller (the second customer computer 14) money ($100) from the buyers bank account (1234646) maintained by the buyers bank (the first bank computer 16) to the seller's bank (the second bank computer 18) on a certain date (Jun. 30, 2002). A conditional payment order instruction may include data similar to a payment order except that payment may be based on a condition (e.g. that the goods are to be delivered at a particular warehouse). A payment obligation instruction may include data similar to a payment order except that the buyer cannot revoke this instruction without the agreement of the seller. A conditional payment obligation is similar to a payment obligation except that the buyer is not obliged to make the payment until a certain condition(s) specified on the payment is met.

A certified payment obligation is a payment instruction that may not be able to be revoked and where a bank guarantees payment instead of the company. This may be more valuable to a recipient because certainty of payment may be higher than with a guarantee provided by a company. A conditional certified payment obligation is similar to a certified payment obligation except that the guarantee provided by a bank is conditional.

The payment obligation instructions above (3, 4, 5, and 6) may not be revocable, whereas payment orders (1) and conditional payment orders (2) may be revocable, but only prior to processing by the bank. Once an instruction has been processed by a bank, it may be difficult to revoke it.

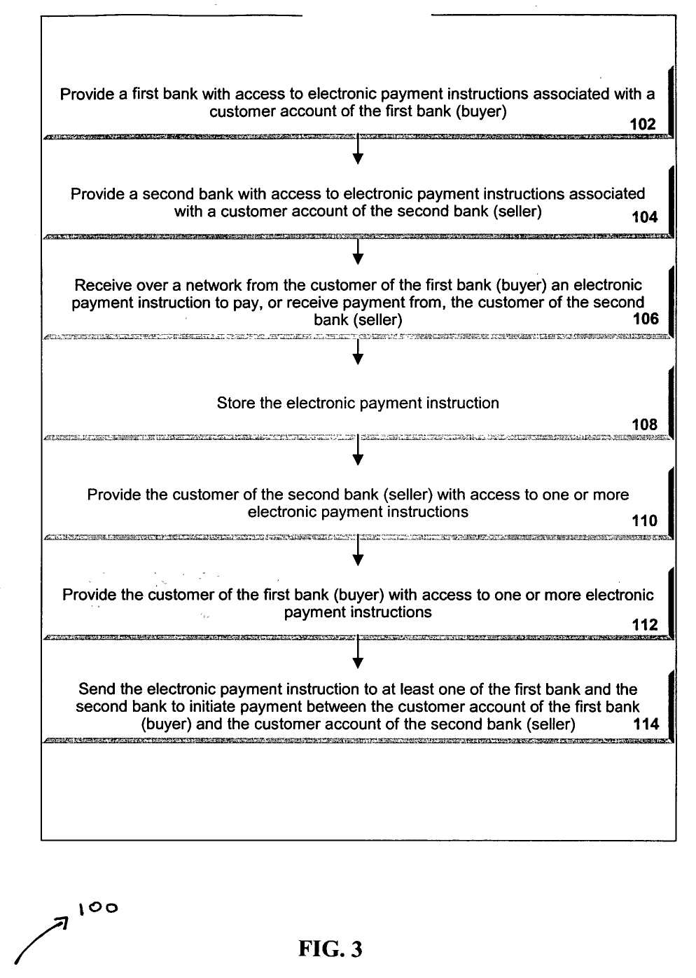

FIG. 3 is a flow diagram 100 of an electronic payment system 10 according to an embodiment of the invention. The flow diagram 100 illustrates an example of how the electronic payment system 10 may allow a buyer using a first customer computer 12 to enter into a business transaction for the purchase of goods from a seller of goods using a second customer computer 14 over the network 24. The system also allows for the electronic payment for the goods by allowing payment between the buyers bank (the first bank computer 16) and the seller's bank (the second bank computer 18). The system 10 also shows how the buyer and the seller can view and update information related to the business transaction such as electronic payment instructions.

The server computer 20 provides (block 102) the first bank computer 16 (buyer's bank) with access to electronic payment instructions associated with a customer account of the first bank. In this case, the customer is the buyer represented by the first customer computer 12. The customer can establish bank accounts with the first bank as well as other banks using techniques such as offline, online, a combination of these two techniques, or other techniques. The server computer 20 may require that the first bank, as well as other banks that provide the customer with bank accounts, to register with the server computer 20. Once the banks are registered, they can be provided with access to electronic payment instruction associated with business transaction generated by their customers. The type of access may be based on the relationship between the customers of the bank as well as the relationship between the banks and the server computer 20. For example, the server computer 20 may offer the first bank different levels of service based on cost.

The server computer 20 provides (block 104) the second bank computer 18 (seller's bank) with access to electronic payment instructions associated with a customer account of the second bank. In this case, the customer is the seller represented by the second customer computer 14. The comments made above related to the first bank may be also applicable to the second bank.

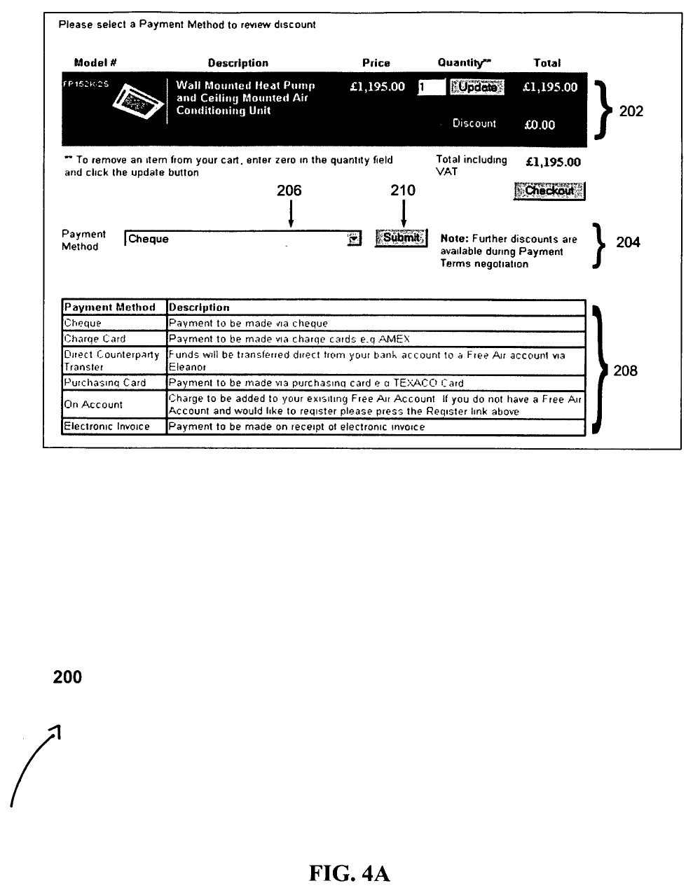

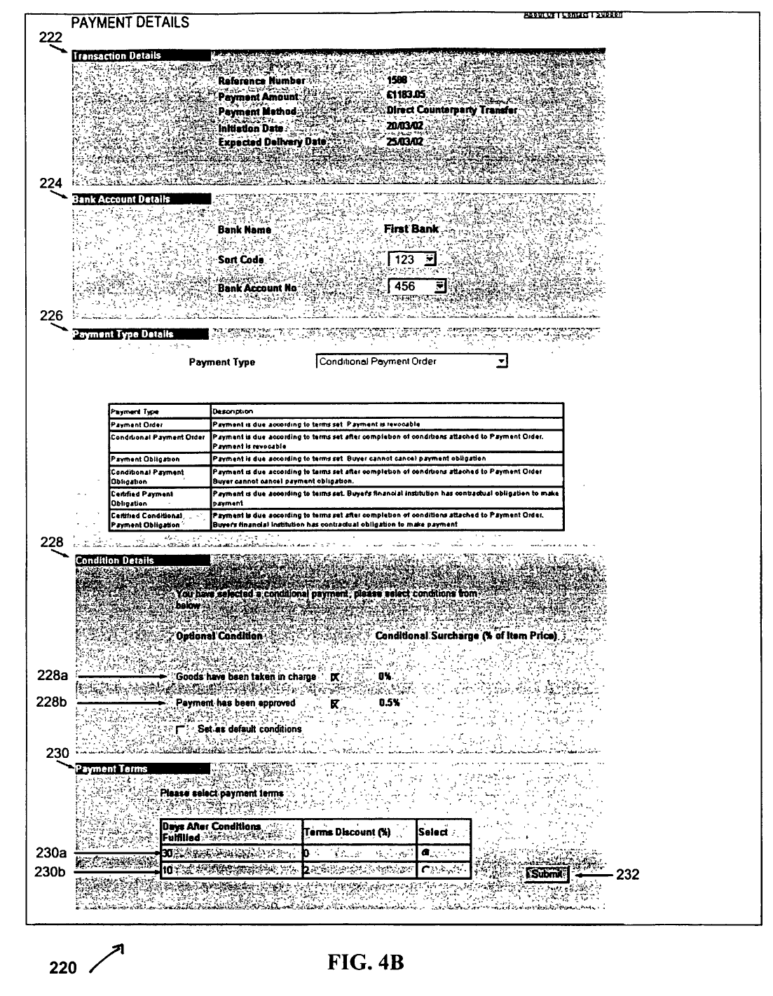

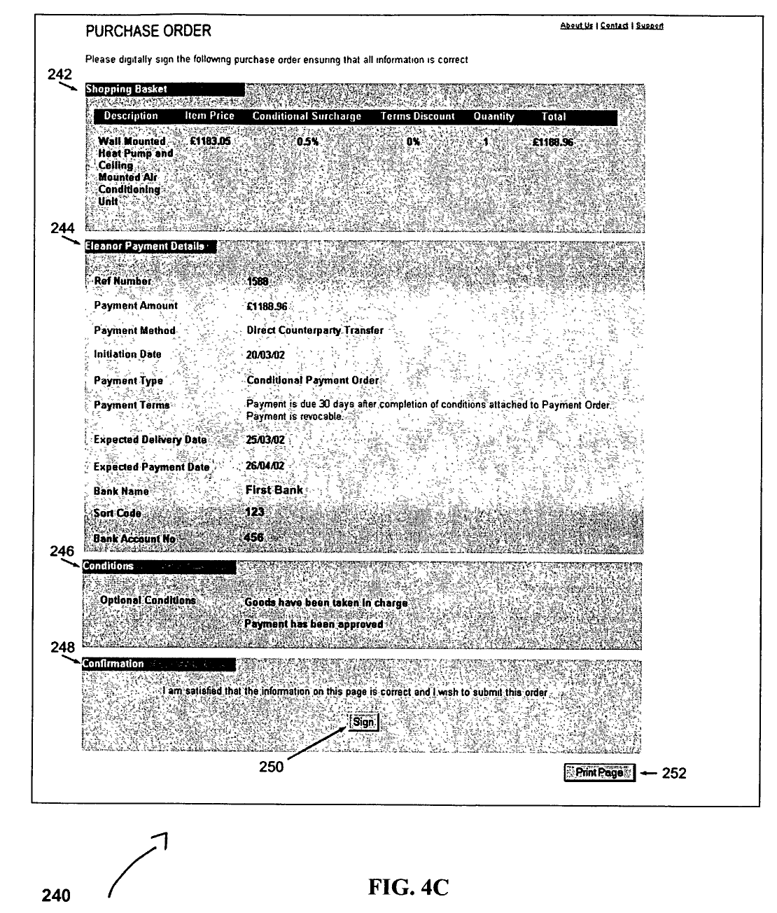

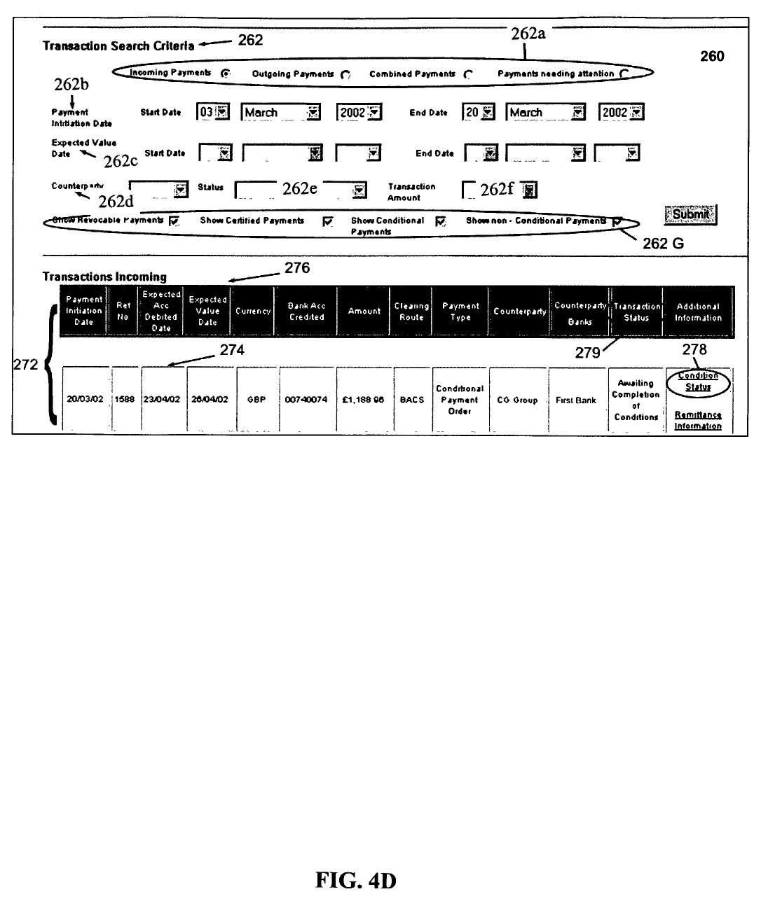

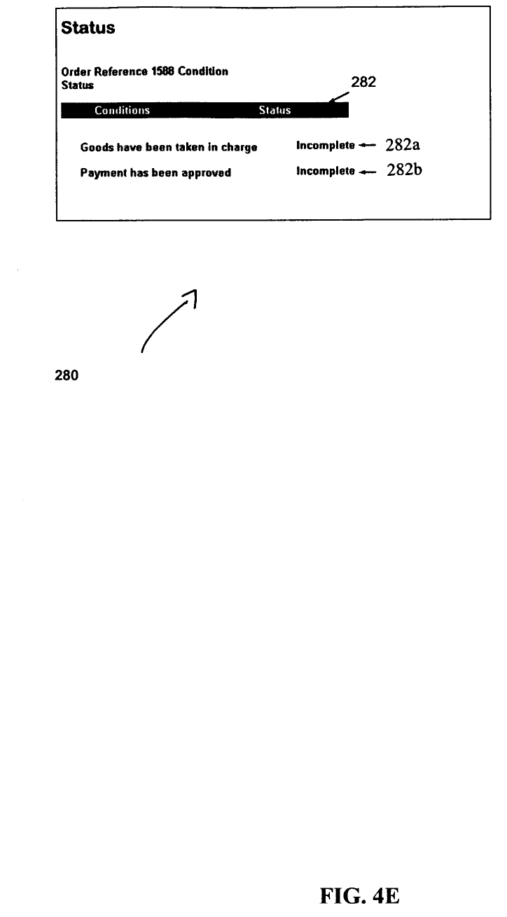

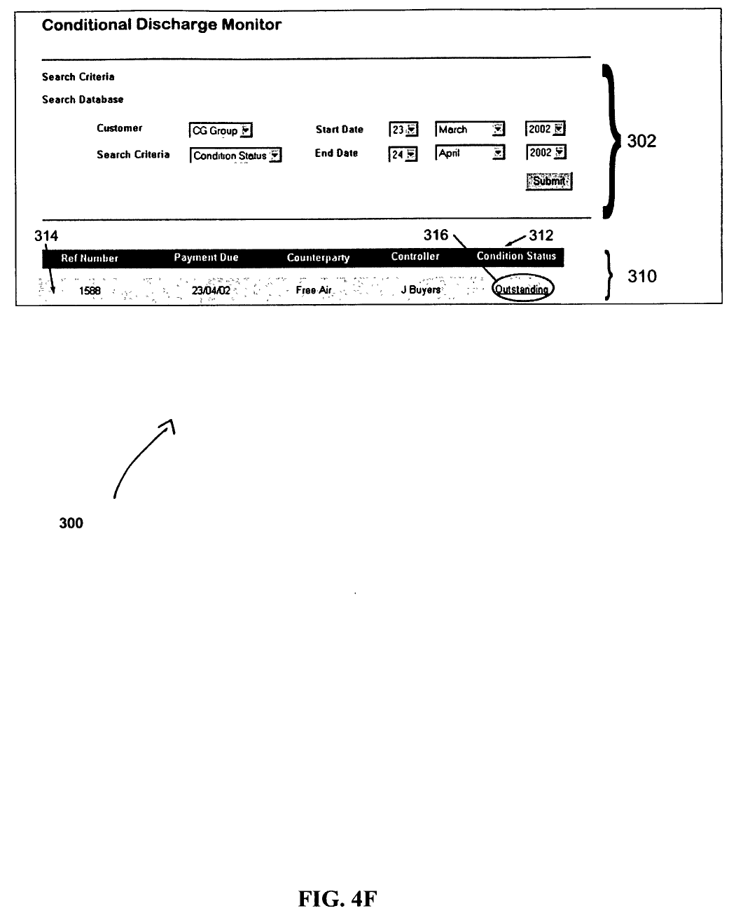

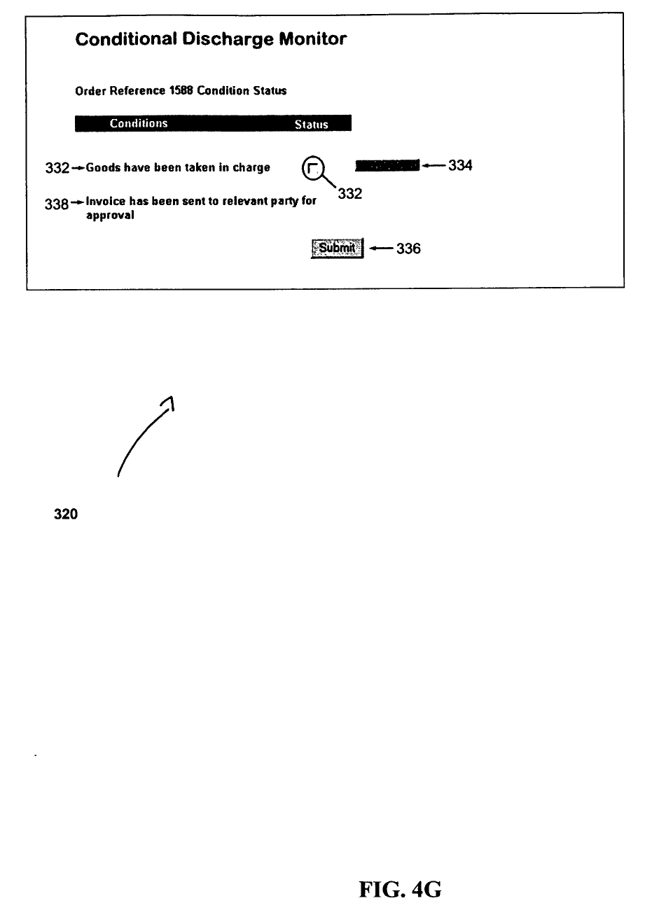

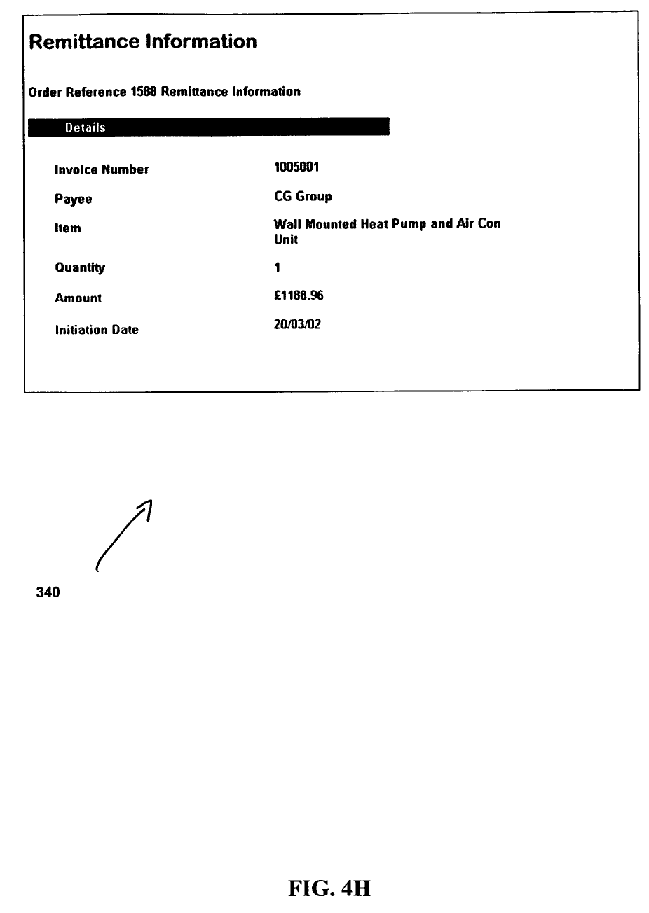

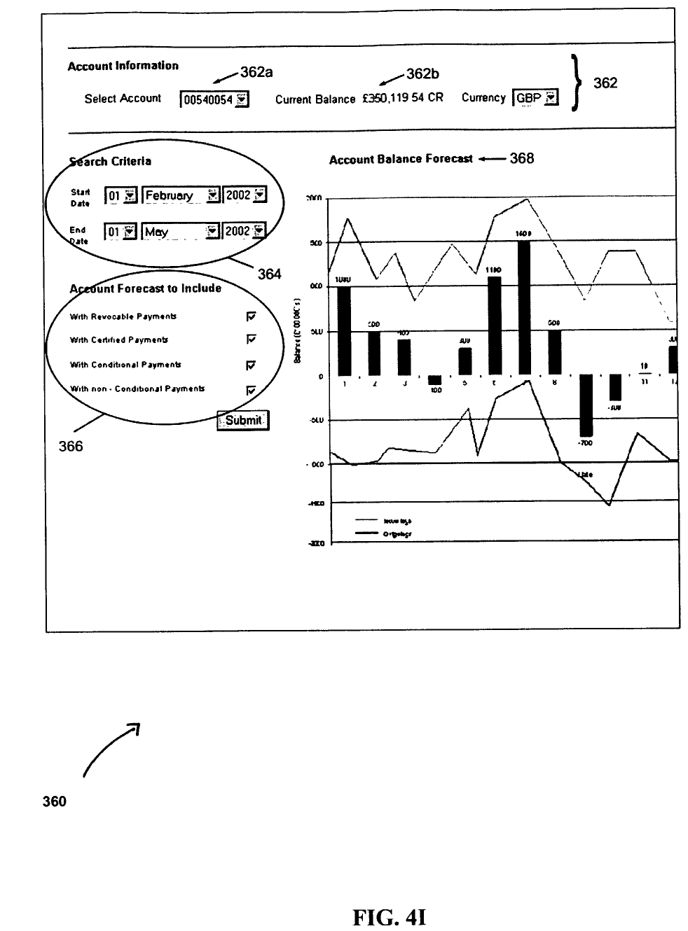

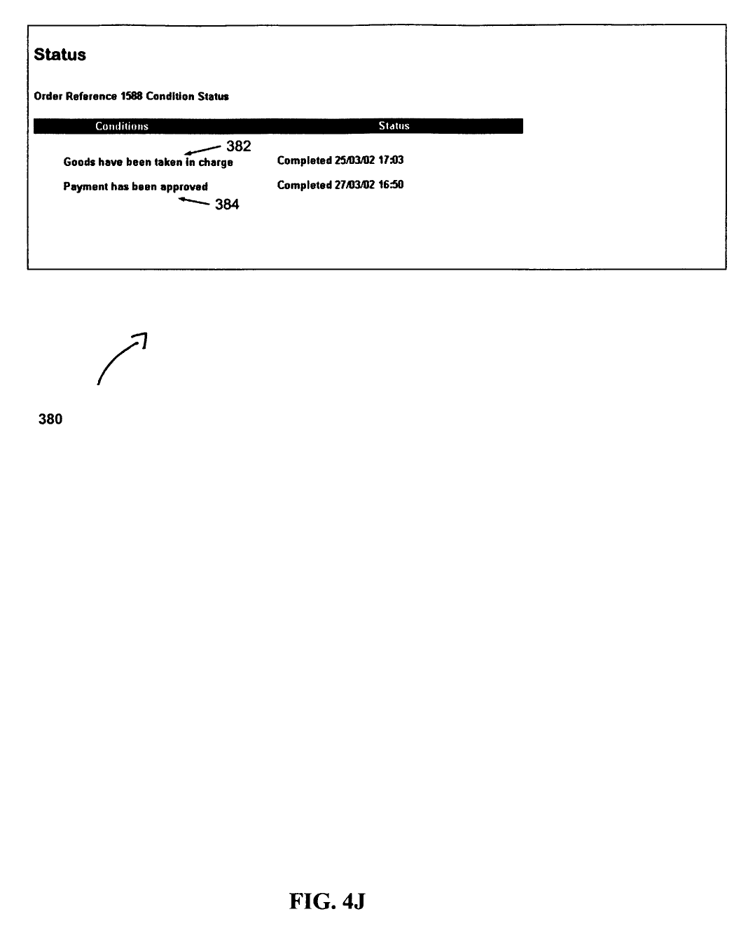

The server computer 20 receives (block 106) over a network 24 from the customer of the first bank (buyer) an electronic payment instruction to pay the customer of the second bank (seller). Typically, the generation of an electronic payment instruction may begin by having the customer of the first bank (buyer) access a Web site provided by the second customer of the second bank (seller). (Alternatively, the generation of payment instructions can be integrated with an existing application such an A/P application.) FIG. 4A shows an example of a product Web page 200 provided by the second customer computer 14 associated with the seller. The product Web page 200 includes a product description section 202, a payment method section 204, and a payment method description section 208. The product description section 202 provides information related to an item(s) for purchase including information such as the model number, description, price, quantity, and total price of the item(s). The payment method section 204 may permit the buyer to select a payment method from a list of payment methods 206 using, for example, a “drop-down” box. The payment method description section 208 provides a list of the different payment methods and a text description of the different payment methods. In this example, the buyer has selected a “heat pump” for purchase and “direct counterparty transfer” as the payment method. Direct counterparty transfer payment method refers to a payment method in which funds are to be transferred direct from the buyer's bank account to the seller's bank account. This payment method may provide the buyer with a 1% percent discount in the purchase price. The parties can agree to other discounts during payment term negotiations which can take place before the actual display of page 200.

Once the buyer has selected the purchase item and the payment method, the buyer clicks the “submit” button 210 which may cause a buyer identification pop-up window to be displayed (not shown). The window may require the buyer to enter identification information such as digital signature information e.g. held on a smart card. The seller (or the server computer) can then check buyer related information including the signature of the buyer and its validity at that point in time.

Once the buyer identity has been verified, the server computer 20 can take over the subsequent display of web pages and can host web pages instead of the seller (if the seller chooses not to). If the buyer is denied access, the server computer can display an alert warning web page (not shown) indicating that access has been denied. For example, as shown in FIG. 4B, the server computer 20 displays a payment details Web page 220 that includes a transaction details section 222, a bank account details section 224, a payment type details section 226, a condition details section 228, and a payment terms section 230.

The transaction details section 222 may allow the buyer to check information related to the business transaction identified by a reference number assigned to the transaction (1588), the payment amount (£1183.05 which reflects the 1% discount mentioned above), payment method (direct counterparty transfer), the date the transaction was initiated (Mar. 3, 2002), and the expected delivery date (Mar. 25, 2002).

The bank account details section 224 shows the name of the bank (first bank) selected by the buyer to make payment, the sort code (123) associated with the first bank, the bank account number (456) of the buyers' bank account maintained at the first bank. The server computer 20 may allow the buyer to select from a list (e.g. drop-down box) of one or more bank accounts maintained at one or more banks. The banks may have provided the server computer 20 with information related to the different bank accounts of their customers. As a result, the server computer 20 may be able to provide the buyer (or the seller if the seller initiated a purchase) with a single display/screen containing user selectable bank accounts from one or more different banks.

The payment type details section 226 provides a list of user selectable payment types described above. In this example, the buyer has chosen the “conditional payment order” payment type from the list. The condition details section 228 is displayed if the buyer has selected a conditional payment type. As mentioned above, in this example, the user has selected the “conditional payment order” payment type which causes condition fields to be displayed such as, for example, a first condition 228a and a second condition 228b. The first condition 228a specifies that the buyer may be able to make payment conditioned on whether the goods have been taken in charge (accepted). The second condition 228b provides the buyer an option to make payment based upon approval by the buyer. These optional conditions may provide the buyer with greater flexibility with payment transactions (the seller may also choose to stipulate conditions that are not optional e.g. the buyer to provide their own transport for carriage of goods). The buyer has selected (indicated by the check mark) the first condition 228a which does not place a surcharge on the transaction. The buyer has also chosen to select the second condition 228b which places an additional 0.5% surcharge on the transaction. The server computer 20 can display different selectable conditions or options on the Web page 220 based on previously stored conditions negotiated between the buyer and the seller.

The payment terms section 230 displays terms that may be attached to the payment transaction. For example, a first term 230a indicates that if payment is made 30 days after the conditions have been fulfilled, then the payment transaction is not subject to a discount. Similar, a second term 230b indicates that the buyer has the option of receiving a 2% discount if payment is made within 10 days of the fulfillment of any conditions. In this example, the buyer has selected the first term 230a option as indicated by the checked “radio button”

Once the buyer has completed the payment details Web page 220, the buyer can click on a “submit” button 232 which may cause a purchase order Web page 240 to be displayed (See FIG. 4C). The purchase order page 240 contains a summary of the business transaction information associated with purchase of the item between the buyer and the seller. The purchase order page 240 may also allow the buyer an opportunity to verify that all the transaction information is correct and then digitally sign the purchase order. The purchase order page 240 includes a shopping basket section 242, a payment details section 244, a conditions section 246, and a confirmation section 248. The shopping basket section 242 provides information related to the purchased item(s) such as the description of the item, item price, conditional surcharge, terms discount, quantity, and total price. The conditional surcharge indicates that the purchase is subject to an additional surcharge of 0.5% as a result of the “payment approved” condition selected by the buyer. (see FIG. 4B) The shopping basket section 242, the payment details section 244, and the conditions section 246 provide a summary of the information entered into the payment details page 220 (see FIG. 4B) by the buyer.

Once the buyer is satisfied with the information and has verified that the information is accurate, the buyer can click on the “sign” button 250 in the confirmation section 248 which causes the purchase order to be submitted. In addition, a confirmation page (not shown) can be sent to the buyer to confirm that the purchase order has been received by the server computer and that payment processing has been initiated. The seller also can be sent a similar alert in the form an Email or other alert mechanism. The server computer 20 may provide the buyer with a print version of the purchase order by having a “print” button 252 on the purchase order page 240.

Once the electronic payment instruction corresponding to the business transaction (purchase of goods by the buyer) has been generated and received by the server computer 20, the server computer 20 stores (block 108) the electronic payment instruction in a storage means such as one or more databases 30. The payment instructions can be stored in the database 30 until conditions, if any, that have been attached to the instructions have been satisfied and/or until a predetermined time period has elapsed (e.g. thirty days). In this example, as described above, the payment instruction contains a condition specifying that payment is not to be made until the goods have been received by the buyer. Thus, the payment instruction is stored in the database 30 and not forwarded to the buyer's bank for payment until thirty days (less the clearing delay) after the goods have been received by the buyer.

The server computer provides (block 110) the customer of the second bank (seller of goods) with access to one or more electronic payment instructions associated with one or more business transactions. In one embodiment, the server computer may provide a transaction page 260 (see FIG. 4D) that includes a summary of incoming payments (representing payments owed to the seller) and outgoing payments (representing payment owed by the seller). Alternatively, the server computer may provide the data, in batch or in real time, for the bank to provide to its customers through its own web pages. The transaction page 260 includes a search criteria section 262 and a transaction display section 272. The search criteria section 262 includes fields that the buyer can choose from to affect the transactions that are displayed on the transaction display section 272. Search criteria can include, for example, payment categories 262a (including incoming, outgoing, or others), payment initiation date 262b (including start and end date), expected value data 262c (including start and the end date), counterparty 262d, status 262e, transaction amount 262f, payment types 262g, or other search criteria. In this example, the seller has selected “incoming payments” from section 262a, and March 2002 as the payment initiation date from section 262b, as shown in the search criteria section 262.

The transactions section 272 displays a row of data for each transaction representing payments that are “incoming” or owed to the seller. In this example, transaction 274 represents the transaction associated with the purchase of goods between the buyer and the seller. The transaction 274 displays data fields that have been stored and subsequently retrieved from the database of the server computer 20. A header 276 provides a description of the data fields on the transaction 274 (or any transaction) such as payment initiation date, reference number, expected account debited date, expected value date, currency, bank account credited, amount, clearing route, payment type, counterparty, counterparty, counterparty banks, and transactions status. The reference number of 1588 identifies the current transaction initiated by the buyer. The transaction status indicates that the payment associated with this transaction is “awaiting completion of conditions”. In this case, the “conditions” may be satisfied when the buyer actually receives the goods purchased.

The seller can view a detailed status report of the conditions associated with transaction 274 by clicking on the “condition status” link 278. In response, a “condition detail” Web page 280 is displayed as shown in FIG. 4E. The page 280 indicates that the information is associated with the transaction 274 having the reference number 1588. Each transaction can have one or more conditions 282 and a corresponding status. The first condition 282a indicates whether the buyer has received the goods. Likewise, the second condition 282b indicates whether payment has been approved. In both cases, the status of the conditions is shown as “incomplete.” As is described below, once the buyer receives the goods and approves payment, the status will be updated to indicate “complete” and the seller will receive payment.

In addition, the server computer 20 may be able to provide the seller the ability to set specific terms as well as conditions for transactions generated by the buyer. For example, suppose that the buyer is a company and that the company contains one or more departments. The seller may be able to set a profile for each department in the company which can be stored in a database maintained by the server computer 20. The profile can include information such as a limit value specifying the maximum amount that can be purchased by the department (or company), the payment period reflecting the length of time for payment, payment conditions, or other information. Once the server computer receives a payment instruction from a department in the company having a profile, the server computer retrieves the profile and formats the terms and conditions of the payment instructions based on the profile information associated with the department.

The seller also may be able to sell a payment associated with the buyer transaction to a third party bank (or to the first or second bank). For example, the server computer 20 can provide a web page that may allow the seller to sell the payment to a third party bank (including the seller's own bank or even the buyer's bank). Once any conditions attached to the payment are satisfied, the payment instruction can be sent to the buyer's bank with the third party bank acting as the beneficiary and receiving payment instead of the seller's bank. As a result, the seller can receive a discounted amount from the third party bank in exchange for selling the payment obligation to the third party.

In a similar manner, the server computer 20 provides (block 112) the customer of the first bank (buyer) with access to one or more electronic payment instructions associated with one or more business transactions. In one example, the server computer 20 generates a conditional discharge monitor Web page 300 that includes a search section 302 and a transaction display section 310.(see FIG. 4F) Similar to the search criteria section 262 of FIG. 4D, the search section 302 includes fields that may allow the buyer to search the payment instruction database. The buyer can conduct a search based on criteria such as customer, payment status, start date, end date, or other criteria. The transaction display section 310 includes a transaction header 312 and a list of transactions that satisfy the search criteria data entered in the search criteria section 302. In this example, transaction 314 having reference number 1588 is associated with transaction initiated by the buyer. The header 312 includes columns specifying data field for a transaction such as reference number, payment due, counterparty, controller, condition status, or other data. Although not shown, the buyer can be provided with a transaction page 260 similar to the transaction page (see FIG. 4D). In addition, this page can be accessed by authorized users of the bank or third party that may perform a conditional discharge. These parties can fulfill the conditions on behalf of a participant in a transaction, in this example, the buyer. For example, the seller can update the condition to indicate that the goods have been delivered. In addition, from the third party computer (computer 29 in FIG. 1) a third party can update the condition to indicate that the goods have passed inspection.

In this example, the transaction has a reference number 1588 and the condition status indicates that it is “outstanding.” The buyer views additional detailed data regarding the status of the case by clicking on the condition status link specified by “outstanding” link 316. As a result, a detailed view 320 (See FIG. 4G) is provided that allows the buyer to update the status of the transaction. A first condition 332 is displayed which allows the buyer to click on a “check box” 332 to indicate that the goods have been received. Alternatively, the buyer can choose to waive the condition by clicking on the “waiver” button 334. Once the buyer has updated the condition related to the transaction, the buyer can send the updated information to the server computer by clicking on the “submit” button 336. The text 338 indicates that an invoice has been sent out to an authorized entity that can approve the transaction. Once the buyer has clicked on the submit button and returned to the previous conditional discharge monitor screen 300 of FIG. 4F, the screen indicates the updated status as being “met” (not shown).

In addition, the server computer can provide the buyer with remittance information associated with the transaction. For example, FIG. 4H shows a remittance information Web page 340 that includes remittance information associated with the current transaction. An invoice number 1005501 indicates the invoice associated with the transaction having the reference number 1588. As a result, the buyer has invoice and payment information on a single page which may reduce the need to match invoice and payment information from different sources.

Moreover, the server computer may be capable of providing the buyer (or seller) with account information from one or more different banks. For example, FIG. 4I shows a banking chart screen 360 that includes an account information section 362, search criteria section 364, account forecast section 366, and an account balance graph section 368. The account information section 362 provides a “drop down box” 362a containing a list of one or bank accounts. The buyer can select a bank from the list to make payment for a transaction. An account balance field 362b provides a balance amount associated with the displayed bank account. The search criteria section 364 allows the buyer to enter beginning and ending date for payment transactions and which transaction types to display. The account balance forecast section 366 allows the buyer to view different types of payment types. The account balance forecast graph 368 shows a chart of account balance information for both incoming transactions and outgoing transactions.

Once the condition(s) associated with the electronic payment instructions has been met and the processing date, calculated by rules in the electronic payment program 22, has arrived, the server computer 20 sends (block 114) the electronic payment instruction to at least one of the first bank and the second bank to initiate payment between the customer account of the first bank (buyer) and the customer account of the second bank (seller). The first bank can then proceed to debit the buyer's account by sending the payment instruction to the clearing network 26. Once the clearing network 26 clears the transaction, the second bank associated with the seller receives the payment and credits the seller's account. Alternatively, the payment instruction could be sent to the seller's bank instead of to the buyer's bank depending on the rules of the clearing network maintained by the server computer.

In addition, the seller can access status page 380 of a transaction page (see FIG. 4J) to view the current status of the conditions of the transaction. The status indicates a first condition 382 was satisfied when the buyer received the goods on Mar. 25, 2002. A second condition 384 was satisfied Mar. 27, 2002 when payment was approved. The two-day delay is due to the approvals process.

In another example, the buyer and seller can also access information about a payment instruction such as clearing status, which is provided to the server computer 20 by at least one of the clearing network 26, the first bank computer 16 and the second bank computer 18, or inferred by rules within the electronic payment program 22 in the server computer. For example, in FIG. 4D, the transaction status column 279 can be used to show where a payment is within a clearing cycle e.g. day 2 within the three day BACS clearing cycle.

In another example, banks also can use these techniques to net off payment instructions between their customers. In this example, when a payment is due, instead of sending the payment instruction to the appropriate bank for processing and routing to the appropriate mechanism in the clearing network, the payment instruction can be aggregated with other payment instructions that are due. Payment instructions that are due to be sent from the first bank to the second bank can be netted off against payments instructions due to be sent from the second bank to the first bank. This netting off is performed over a period of time (e.g. a day, an hour, a minute), and at the end of the period, one single payment instruction between the two banks is produced, either from the first bank to the second bank, or from the second to the first bank. The banks may still need to receive the original payment instructions to debit and credit the appropriate customer accounts, but only one payment for the period need be cleared through the banks' chosen inter-bank clearing network. Banks using these techniques can choose to net off their payment instructions in this manner, according to the rules described above (e.g. payment type, urgency, size, recipient, originator, recipient's bank, originator's bank).

A number of embodiments of the invention have been described. Nevertheless, it will be understood that various modifications may be made without departing from the spirit and scope of the invention. For example, the seller may be able to purchase items from the buyer or other sellers over the network. The server computer 20 could process electronic payment instructions generated by the seller in a similar manner as to the electronic payment instructions generated by the buyer in the above example. In the example given in this detailed description, the buyer interacts with the seller through the seller's website. Other possible examples include, but are not limited to: a buyer initiating an electronic payment or money movement instruction from an accounts payable, cash management, electronic-procurement, order management, electronic bill/invoice presentment and payment, or supply chain computer system; a supplier initiating an electronic payment or money movement instruction, or requesting payment information from a buyer, from an accounts receivable, cash management or supply chain computer system.

Accordingly, other embodiments are within the scope of the following claims.

What is claimed is:

1. A method of managing electronic payment instructions comprising:
providing a first bank with access to electronic payment instructions associated with a customer account of the first bank;
providing a second bank with access to electronic payment instructions associated with a customer account of the second bank;
receiving over a network from the customer of the first bank an electronic payment instruction to pay, or receive payment from, the customer of the second bank;
storing the electronic payment instruction; and
sending the electronic payment instruction to at least one of the first bank and the second bank to initiate payment between the customer account of the first bank and the customer account of the second bank.

2. The method of claim 1 further comprising:
receiving from the customer of the second bank an electronic payment instruction to pay, or receive payment from, a customer of the first bank;
storing the electronic payment instruction; and
sending the instruction to at least the second bank and the first bank to initiate payment between the customer account of the second bank and customer account of the first bank.

3. The method of claim 1 further comprising:
providing the customer of the first bank with access to configure rules associated with the electronic payment instruction, including rules for each customer, and entity level associated within a customer, of the second bank

4. The method of claim 1 further comprising:
providing at least the customer of the first bank, the customer of the second bank, and a third party with access to update information with the electronic payment instruction.

5. The method of claim 1 further comprising:
providing a bank with access to transfer ownership of a payment obligation associated with an electronic payment instruction from the customer of one bank to that bank or to any other bank having access.

6. The method of claim 1 further comprising:
providing a customer of the first bank with access to approve an electronic payment instruction before it is sent to the second bank.

7. The method of claim 1 further comprising:
providing a customer with access to view separate and combined account balance information from accounts maintained at different banks; and
providing the customer with access to select at least one account from at least one bank to be included in a payment instruction.

8. The method of claim 1 further comprising:
providing the customer of a bank with access to one or more electronic payment instructions in a database; and
providing the customer with access to view incoming or outgoing payment instructions associated with that customer.

9. The method of claim 1 further comprising:
receiving from the bank or from a clearing network information on the status of a payment instruction; and
providing the customer with access to view information about the electronic payment instruction.

10. The method of claim 9 wherein the information includes at least one of condition status, clearing route and clearing status.

11. The method of claim 1 further comprising:
providing the customer of the first bank with access to services provided by the first, second or other banks.

12. The method of claim 1 wherein the first customer and the second customer are engaged in the exchange of at least goods and services over the network.

13. The method of claim 1 further comprising sending to the first and second banks a net electronic payment instruction based on net of one or more electronic payment instructions between customers of the first and the second bank.

14. The method of claim 13 further comprising storing rules for each bank for producing the net electronic payment instruction.

15. An apparatus for managing electronic payment instructions, comprising:
a memory; and
a processor coupled to the memory, wherein the processor is configured to:
provide a first bank with access to electronic payment instructions associated with a customer account of the first bank,
provide a second bank with access to electronic payment instructions associated with a customer account of the second bank,
receive over a network from the customer of the first bank an electronic payment instruction to pay, or receive payment from, the customer of the second bank,
store the electronic payment instruction, and
send the electronic payment instruction to at least one of the first bank and the second bank to initiate payment between the customer account of the first bank and the customer account of the second bank.

16. The apparatus of claim 15 wherein the processor is further configured to:
receive from the customer of the second bank an electronic payment instruction to pay, or receive payment from, a customer of the first bank;
store the electronic payment instruction; and
send the instruction to at least one of the second bank and the first bank to initiate payment between the customer account of the second bank and customer account of the first bank.

17. The apparatus of claim 15 wherein the processor is further configured to:
provide the customer of the first bank with access to configure rules associated with the electronic payment instruction, including rules for each customer, and entity level associated within a customer, of the second bank

18. The apparatus of claim 15 wherein the processor is further configured to:
provide at least one of the customer of the first bank, the customer of the second bank, and a third party with access to update information with the electronic payment instruction.

19. The apparatus of claim 15 wherein the processor is further configured to:
provide a bank with access to transfer ownership of a payment obligation associated with an electronic payment instruction from the customer of one bank to that bank or to any other bank having access.

20. The apparatus of claim 15 wherein the processor is further configured to:
provide a customer of the first bank with access to approve an electronic payment instruction before it is sent to the second bank.

21. The apparatus of claim 15 wherein the processor is further configured to:
provide a customer with access to view separate and combined account balance information from accounts maintained at different banks; and
provide the customer with access to select at least one account from at least one bank to be included in a payment instruction.

22. The apparatus of claim 15 wherein the processor is further configured to:
provide the customer of a bank with access to one or more electronic payment instructions in a database; and
provide the customer with access to view incoming and outgoing payment instructions associated with that customer.

23. The apparatus of claim 15 wherein the processor is further configured to:
receive from the bank or from a clearing network information on the status of a payment instruction; and
provide the customer with access to view information about the electronic payment instruction.

24. The apparatus of claim 23 wherein information includes at least one of condition status, clearing route and clearing status.

25. The apparatus of claim 15 wherein the processor is further configured to:
provide the customer of the first bank with access to services provided by the first, second or other bank.

26. The apparatus of claim 15 wherein the first customer and the second customer are engaged in the exchange of at least goods and services over the network.

27. The apparatus of claim 15 wherein the processor is further configured to send to the first and second banks a net electronic payment instruction based on net of one or more electronic payment instructions between customers of the first and the second bank.

28. The apparatus of claim 27 wherein the processor is further configured to store rules for each bank for producing the net electronic payment instruction.

29. An article comprising a computer-readable medium that stores executable instructions for causing a computer system to:
provide a first bank with access to electronic payment instructions associated with a customer account of the first bank;
provide a second bank with access to electronic payment instructions associated with a customer account of the second bank;
receive over a network from the customer of the first bank an electronic payment instruction to pay, or receive payment from, the customer of the second bank;
store the electronic payment instruction; and
send the electronic payment instruction to at least one of the first bank and the second bank to initiate payment between the customer account of the first bank and the customer account of the second bank.

30. The article of claim 29 further comprising instructions for causing a computer system to:
receive from the customer of the second bank an electronic payment instruction to pay, or receive payment from, a customer of the first bank;
store the electronic payment instruction; and
send the instruction to at least one of the second bank and the first bank to initiate payment between the customer account of the second bank and customer account of the first bank.

31. The article of claim 29 further comprising instructions for causing a computer system to:
provide the customer of the first bank with access to configure rules associated with the electronic payment instruction, including rules for each customer, and entity level associated within a customer, of the second bank

32. The article of claim 29 further comprising instructions for causing a computer system to:
provide at least the customer of the first bank, the customer of the second bank, and a third party with access to update information with the electronic payment instruction.

33. The article of claim 29 further comprising instructions for causing a computer system to:
provide a bank with access to transfer ownership of a payment obligation associated with an electronic payment instruction from the customer of one bank to that bank or to any other bank having access.

34. The article of claim 29 further comprising instructions for causing a computer system to:
provide a customer of the first bank with access to approve an electronic payment instruction before it is sent to the second bank.

35. The article of claim 29 further comprising instructions for causing a computer system to:
provide a customer with access to view separate and combined account balance information from accounts maintained at different banks; and
provide the customer with access to select at least one account from at least one bank to be included in a payment instruction.

36. The article of claim 29 further comprising instructions for causing a computer system to:
provide the customer of a bank with access to one or more electronic payment instructions in a database; and
provide the customer with access to view incoming and outgoing payment instructions associated with that customer.

37. The article of claim 29 further comprising instructions for causing a computer system to:
receive from the banks or from a clearing network information on the status of a payment instruction; and
provide the customer with access to view information about the electronic payment instruction.

38. The article of claim 29 further comprising instructions for causing a computer system to:
provide the customer of the first bank with access to services provided by the first, second or other bank.

39. The article of claim 29 further comprising instructions for causing a computer system to:
send to the first and second banks a net electronic payment instruction based on net of one or more electronic payment instructions between customers of the first and the second bank.

40. The article of claim 39 further comprising instructions for causing a computer system to store rules for each bank for producing the net electronic payment instruction.
